(19) United States
(12) Patent Application Publication
(10) Pub. No.: US 2022/0175501 A1
(43) Pub. Date: Jun. 9, 2022

(54) Apparatus and Method for Three-Dimensional Laminating and Coloring a Dental Ceramic Crown

(71) Applicant: FRANZ COLLECTION INC., Taipei City (TW)

(72) Inventors: Feng-Ming YEN, Taipei City (TW); Chun-Jung YEN, Tainan City (TW); Nai-Hui LIU, Taoyuan City (TW)

(21) Appl. No.: 17/135,673

(22) Filed: Dec. 28, 2020

(30) Foreign Application Priority Data
Dec. 7, 2020 (TW) 109142993

(51) Int. Cl. A61C 13/08; A61C 13/083; A61C 13/09; C04B 35/488; C04B 35/64

(52) U.S. Cl. CPC A61C 13/082; A61C 13/083; A61C 13/09; C04B 2235/66; C04B 35/64; C04B 2235/9661; C04B 35/4885

(57) ABSTRACT

An apparatus for three-dimensional laminating and coloring a dental ceramic crown includes a slurry layering module, a coloring module, a light curing module and a main controller. The main controller controls the slurry layering module to lay a slurry from a slurry tank to form a slurry layer, controls the coloring module to color the slurry layer with the colorant in a color tank to form a colorant layer according to a plurality of coloring parameter data, controls the light curing module to cure the slurry layer according to a plurality of laminated graphics. The apparatus may color each slurry layer, and the color can be easily changed as desired. The overall coloring effect of the dental ceramic crown is natural with good light transmittance, and the color is saturated without any blooming formed between the colored layers.

### BACKGROUND OF THE INVENTION

### 1. Field of the Invention

The present invention relates to an apparatus and method for three-dimensional laminating and coloring a dental ceramic crown, in particular to an apparatus and method for forming and coloring a ceramic green body during three-dimensional lamination, simultaneously.

### 2. Description of the Related Art

The color of dental crowns varies with race, region, and lifestyle. In general, the homonymous teeth of the upper jaw are not consistent with those of the lower jaw in color. In addition, the color of teeth is also closely related to age. The brightness of the natural teeth gradually decreases, and the color gradually becomes thicker along with grow in age. Furthermore, the natural teeth of the human kind are not of a single color, and the dental cervical portion, body, and incisal portion or an occlusal portion are different from each other in color. The incisal portion or the occlusal portion are brightest while the dental cervical portion has the maximum chroma. It is thus apparent that, in the traditional process of manufacturing dental ceramic crowns, coloring the dental ceramic crowns is a very important and complicated work, and it is a task that challenges the experience and ability of dental technicians.

In existing art for coloring zirconia ceramic articles, there are primarily two coloring techniques, namely an internal dyeing technique and an external dyeing technique. According to the internal dyeing technique, colored oxides are directly added into the raw ceramic material uniformly, or the ceramic article is pre-dyed, so that the raw ceramic article is colored before formation. According to the external dyeing technique, after the ceramic article is processed to form the dental prosthetic, it is immersed in a dyeing solution and then dried before sintered.

For example, as disclosed in Taiwanese Patent Publication No. I562972 entitled “Gradient ceramic block of dental mold and manufacturing method thereof”, the ceramic block that is processed by CAD/CAM is usually dyed in advance, so that the ceramic block has a color gradient. However, this method can only produce ceramic crowns with a standard gradient staining effect, and the boundaries between different stained layers are distinct, and are stacked regularly and unnatural. Moreover, after turning and shaping to form the dental prosthetic, it is still necessary to match the dental prosthetic with the patient's natural side teeth and colored before sintered. Accordingly, it is still a task that challenges the dental technician's experience and ability in color matching and coloring.

It is thus urgently needed to provide a manufacturing apparatus and method for dental ceramic crowns that may automatically form and color the dental ceramic crowns.

### SUMMARY OF THE INVENTION

The main object of the present invention is to provide a method for forming and coloring a dental ceramic crown during three-dimensional lamination, wherein the color is quite natural, with good light transmittance, and can be customized to gradient coloring according to the color of the patient's remaining natural teeth, thereby eliminating or greatly reducing the color matching and coloring operations after the dental crown has been formed according to the traditional manufacturing process. The hardness and service life of the crown produced are not compromised, and the coloring process can be easily controlled.

To achieve the above objects, an apparatus for three-dimensional laminating and coloring a dental ceramic crown according to the present invention mainly includes a slurry layering module having a slurry tank receiving a slurry therein; a coloring module having at least one colorant tank storing a colorant therein; a light curing module; and a main controller electrically connected to the slurry layering module, the coloring module and the light curing module. The main controller comprises a memory module storing a plurality of laminated graphics and a plurality of coloring parameter data corresponding to the plurality of laminated graphics, the laminated graphics are obtained by slicing a three-dimensional image for the dental ceramic crown in a predetermined direction at a predetermined thickness. The slurry layering module is controlled by the main controller to uniformly lay the slurry from the slurry tank to form a slurry layer. The coloring module is controlled by the main controller according to the plurality of coloring parameter data to color the slurry layer with the colorant in the at least one color tank to form a colorant layer. The light curing module is controlled by the main controller to cure the slurry layer according to a plurality of laminated graphics.

According to the present invention, after a slurry layer is layered by the slurry layering module, the slurry layer is colored, and is then cured to form a predetermined shape. As such, the present invention can color each slurry layer, and can also change the coloring effect of each colorant layer as desired. As such, the coloring effect of the dental ceramic crown is quite natural, with good light transmittance, and the color is saturated without any blooming formed between the adjacent colored layers. It is possible to form various fine patterns on an outer surface of the dental ceramic crown in this manner.

Preferably, the main controller of the present invention may categorize the plurality of coloring parameter data into a plurality of coloring groups. The coloring groups may color the slurry layer with different amounts or colors. In other words, the present invention may use the coloring parameter data to categorize all the colorant layers into a plurality of coloring groups, in which the colorant layers in the same coloring group have the same color or the same spray coating amount, while the color formation performance among different coloring groups is designed to be different. As such, the gradient effect or other diversified display effects may be presented. In addition, the main controller of the present invention can categorize a plurality of coloring parameter data into a plurality of coloring groups based on different RGB color codes, so as to be readily compatible with existing inkjet control methods.

On the other hand, the spray coating amount of the plurality of coloring groups to color the slurry layer gradually decreases from the cervical portion toward the incisal portion or an occlusal portion of the crown to be formed. Accordingly, the present invention may present the color gradient of natural teeth by controlling the spray coating amount of the colorant that decreases from the crown cervical portion to the incisal portion or an occlusal portion.

In addition, the colorant used in the present invention can be a solution mixture of a solvent and at least one material selected from the group consisting of ferric nitrate, ferric chloride, praseodymium nitrate, and praseodymium chloride, or a solution mixture of a solvent and at least one material selected from the group consisting of erbium nitrate, erbium chloride, neodymium nitrate, neodymium chloride, cerium nitrate, and cerium chloride. The solvent can be selected from the group consisting of water, methanol, ethanol, isopropanol, n-propyl alcohol, polar aprotic liquid and ethyl acetate.

To achieve the above object, a method for three-dimensional laminating and coloring a dental ceramic crown of the present invention includes a step (Sa) of preparing a slurry, at least one colorant, a plurality of laminated graphics and a plurality of coloring parameter data, wherein the plurality of laminated graphics are obtained by slicing a three-dimensional image for the dental ceramic crown to be formed in a predetermined direction at a predetermined thickness, and the plurality of coloring parameter data correspond to the plurality of laminated graphics; a step (Sb) of laying the slurry uniformly on a substrate to form a slurry layer; a step (Sc) of coloring the slurry layer with at least one colorant according to one of the plurality of coloring parameter data to form a colorant layer; a step (Sd) of curing the slurry layer according to one of the plurality of laminated graphics; a step (Se) of repeating the step (Sb) to the step (Sd) to form a ceramic crown green body; and a step (Sg) of sintering the ceramic crown green body at a high temperature to form a dental ceramic crown.

Preferably, in the step (Sc), the coloring module uses at least one colorant to color at least a portion of the circumference of the slurry layer to form the colorant layer according to one of the plurality of coloring parameter data. In other words, according to the method of the present invention, in the coloring step, it is not necessary to color the entire slurry layer, but only a partial area is colored. For example, only the surface layer that may be exposed from an oral cavity after the dental ceramic crown is installed shall be colored. Further, the colored region can also be colored with different colors to form various fine patterns.

In addition, the method of the present invention may comprise a step (S0) before the step (Sa), in which a coloring image is obtained by scanning or photographing a reference crown or an original crown to be replaced, and the plurality of coloring parameter data being obtained by slicing in a predetermined direction. In other words, in order to present the original appearance and color of the natural teeth, and to promote the color consistency between the dental ceramic crown and the other adjacent natural teeth, the present invention may first scan or take photos of the natural teeth, side teeth, or homonymous teeth to form a coloring image, and use this coloring image to produce the plurality of coloring parameter data. As such, the process may be fully automated, and no human intervention is required to draft or edit the color images or data for the dental ceramic crown. The color performance resulted is natural.

### BRIEF DESCRIPTION OF THE DRAWINGS

FIG. 1 is a view schematically showing a first embodiment of the present invention;

FIG. 2 is a perspective view of the apparatus according to the first embodiment of the present Invention;

FIG. 3 is a view schematically showing categorization of coloring groups of the dental ceramic crown according to the first embodiment of the present invention;

FIG. 4 is a view schematically showing a coloring image according to a second embodiment of the present invention; and

FIG. 5 is a horizontal cross-sectional vie of a dental ceramic crown according to a third embodiment of the present invention.

### DESCRIPTION OF THE PREFERRED EMBODIMENTS

The present invention is related to an apparatus for three-dimensional laminating and coloring a dental ceramic crown. In the description, similar elements will be denoted by the same reference numerals. In addition, the drawings of the present invention are illustrative, and are not necessarily drawn to scale, and all details are not necessarily be shown in the drawings.

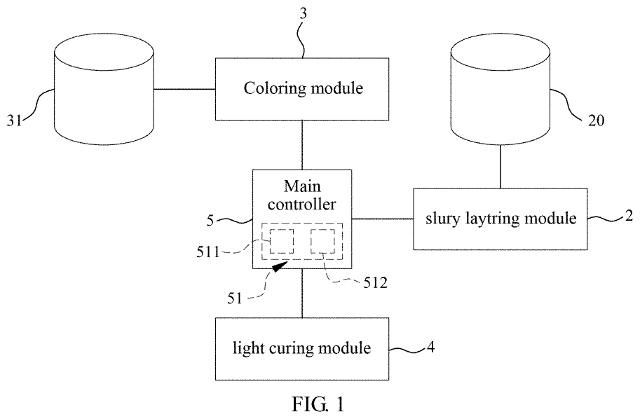

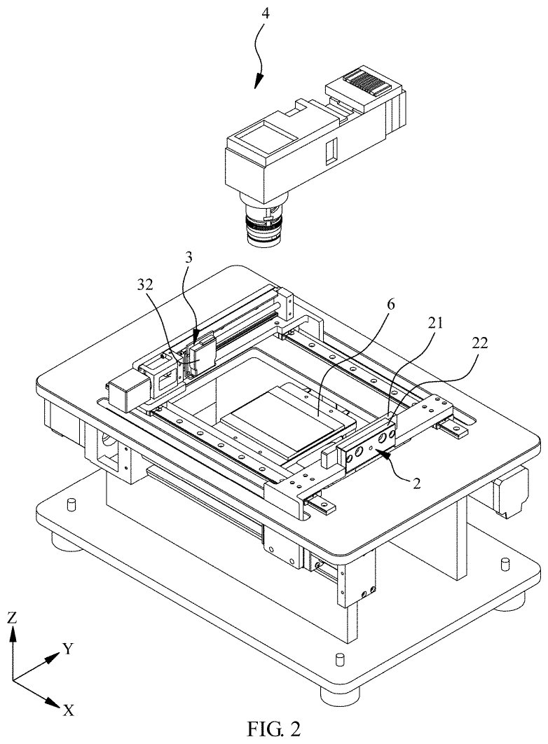

Reference is made to FIGS. 1 and 2, in which FIG. 1 is a view schematically showing an apparatus for three dimensional laminating and coloring a dental ceramic crown according to a first embodiment of the present invention, and FIG. 2 is a perspective view of the apparatus according to the first embodiment. As shown in the figures, the apparatus of this embodiment primarily comprises a slurry layering module 2 having a slurry tank 20, a feeding portion 21 connected to the slurry tank 20, and a flat scraper 22; a coloring module 3; a light curing module 4; and a main controller 5. The slurry tank 20 stores the slurry which is formed of powder material, a photo-curing resin, a solvent and an additive.

The powder material may comprises at least one of alumina powder, zirconia powder, and glass ceramic powder. The photo-curing resin may include at least one of a water-soluble resin and a water-dispersible resin. In this embodiment, the photo-curing resin is mainly composed of 30 wt % to 55 wt % of acrylate monomers, 30 wt % to 40 wt % of acrylate oligomers, 1 wt % to 4 wt % of photoinitiators, and 0 to 2 wt % of additives. The additive may be omitted and can be optionally added. The solvent can be 100% water or a mixed solvent of water and alcohol. For example, the mixed solvent contains water and at least one of ethanol (ET), isopropanol (IPA), propylene glycol (PG) and hexylene glycol (HG). The water is preferably deionized water.

The additives comprise at least one of a dispersant, binding agent, and plasticizer. In particular, the dispersant comprises at least one of polycarboxylate, polymer ammonium salt (such as ammonium polyacrylate), and polymer sodium salt (such as sodium polyacrylate). The plasticizer contains at least one of polyethylene glycol (such as PEG#200, PEG#400) and glycerin (glycerol) having a molecular weight in the range of 150 to 450. The plasticizer is mainly used to reduce the glass transition temperature of the binding agent so that the binding agent has better flexibility at room temperature. In addition, the binding agent comprises at least one of polyethylene glycol (such as PEG#2000, PEG#4000, PEG#6000), polyvinyl alcohol and polyethylene oxide having a molecular weight in the range of 1500 to 8000. The binding agent provides the strength of the ceramic green body after drying to resist the shearing force caused by the flat scraper 22 during laying, and adjusts the viscosity of the slurry to prevent particle sedimentation.

In addition, the bottom surface of the feeding portion 21 is provided with an elongated feeding trough (not shown). The feeding trough has a cross-section substantially in the shape of a funnel, which facilitates the uniform distribution of the slurry on the substrate 6. The flat scraper 22 comprises a blade-like member, and may flatten the slurry laid by the feeding portion 21. As shown in the drawings, the feeding portion 21 and the flat scraper 22 are both arranged on a chassis that can move in the X direction. As such, the slurry layering module 2 performs the layering operation while it is moving in the X direction. That is to say, the slurry is supplied through the feeding portion 21 on one hand, and is scraped over by means of the flat scraper 22 on the other hand.

The coloring module 3 includes a colorant tank 31 and an inkjet head 32. The colorant tank 31 accommodates a colorant which is a solution mixture of a solvent and a first solute group. The first solute group can be ferric nitrate, ferric chloride, praseodymium nitrate or praseodymium chloride. The solution mixture comprises 5 wt % to 20 wt % of the first solute group. The solvent can be water, alcohol (such as methanol, ethanol, isopropanol, and n-propanol), polar aprotic liquid (such as ketone and acetone), ethyl acetate and a mixture of water and alcohol, and/or a mixture of water and ketone. The solution mixture comprises 50 wt % to 95 wt % of the solvent.

Alternatively, in another aspect, the colorant may be a solution mixture of a solvent and a second solute group. The second solute group can be erbium nitrate, erbium chloride, neodymium nitrate, neodymium chloride, cerium nitrate or cerium chloride, and the second solute group is in an amount of 25 wt % to 50 wt %. The solvent may be water, alcohol (such as methanol, ethanol, isopropanol, and n-propanol), polar aprotic liquid (such as ketone and acetone), ethyl acetate, and a mixture of water and alcohol, and/or a mixture of water ketone, and the solvent is in an amount of 50 wt % to 95 wt %.

Alternatively, in a further aspect, the colorant may be a solution mixture of the first and second solute groups and solvents, for example, a mixture of ferric nitrate, erbium nitrate and solvent; a mixture of ferric chloride, erbium chloride and solvent; a mixture of praseodymium nitrate, neodymium nitrate and solvent, or a mixture of praseodymium chloride, neodymium chloride and solvent. In this case, the weight percentage of the solute may be similar to the case mentioned above, while the solvent can be presented in an amount of 30 wt % to 70 wt %. Furthermore, the inkjet head 32 according to this embodiment is a piezoelectric inkjet head, which is superior in its control ability of the colorant ink droplets. As such, high-precision coloring may be readily achieved.

The light curing module 4 according to this embodiment is a DLP (Digital Light Processing) UV optical machine, which is capable of emitting UV light on the slurry according to the laminated graphics to cure the slurry layerwise. It is noted that the substrate 6 of this embodiment is made of a material or structure having a water absorption rate of 5% or more, which is for example, a diatomaceous earth or a ceramic plate having porous medium. As a result, when the slurry is laid on the substrate 6, the substrate 6 may immediately and quickly absorb the moisture in the slurry, thereby greatly reducing the evaporation time of the moisture in the slurry to increase the production efficiency.

The main controller 5 of this embodiment is electrically connected to the slurry layering module 2, the coloring module 3 and the light curing module 4. The main controller 5 comprises a memory module 51 adapted to store a plurality of laminated graphics 511 and a plurality of coloring parameter data 512. The plurality of laminated graphics 511 are obtained by slicing a three-dimensional image for the dental ceramic crown in a predetermined direction at a predetermined thickness. The predetermined thickness corresponds to the layering thickness of the slurry, and the plurality of coloring parameter data 512 correspond to the plurality of laminated graphics 511.

In particular, each laminated graphic 511 is a cross-sectional image formed by slicing the three-dimensional image data for the dental ceramic crown in a horizontal direction at a predetermined thickness. That is, firstly, the three-dimensional image for the dental ceramic crown is transversely sliced layer by layer by an image processing unit to obtain a plurality of laminated graphics 511 based on a given thickness of the reaction layer (layering thickness of the slurry) of a subsequent process. Then, the laminated graphics can be used in the subsequent layerwise curing processes for forming the dental ceramic crown. The three-dimensional image data can be obtained through an optical 3D scanning system or through computer CAD drawing.

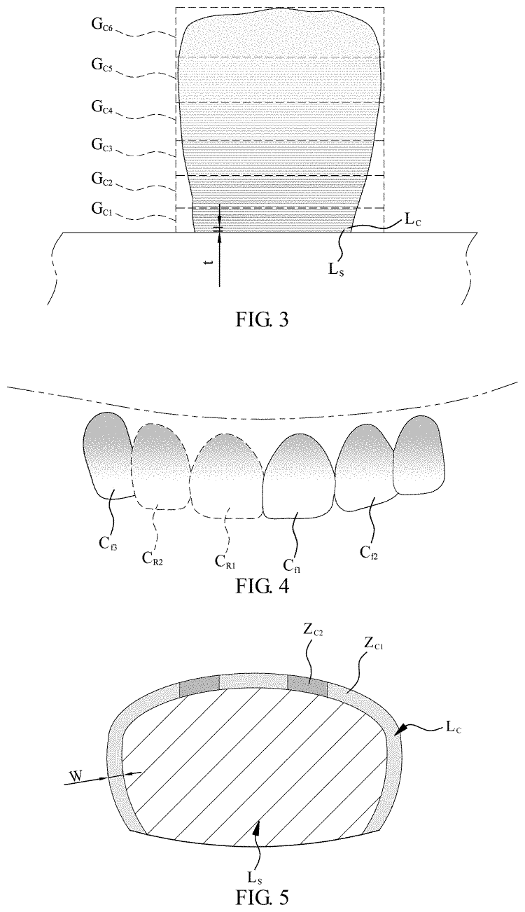

On the other hand, the plurality of coloring parameter data 512 generally correspond to the plurality of laminated graphics 511, that is to say, each laminated graphic 511 corresponds to a respective coloring parameter data 512. The coloring parameter data 512 of this embodiment are obtained by matching the colors of the patient's original teeth to be replaced or adjacent teeth. Now, reference is made to FIG. 3 which is a view schematically showing categorization of coloring groups of the dental ceramic crown according to the first embodiment of the present invention. In this embodiment, the main controller 5 categorizes the a plurality of coloring parameter data 512 into six coloring groups G_{c1}-G_{c6} based on different RGB color codes. The coloring groups G_{c1}-G_{c6} color the slurry layer Lₛ with different spray coating amounts. However, the contents of the coloring parameter data 512 in the same coloring group G_{c1}-G_{c6} are the same (that is, the spray coating amount is the same).

In general, teeth are colored with gradient, that is, thick color gradually transitions to light color from the dental cervical portion to the incisal portion or the occlusal portion. It is given that the predetermined color code of the dental ceramic crown to be formed in this embodiment is A3, the color codes of the six coloring groups G_{c1}-G_{c6} may be A4, A3.5, A3, A2, A1, and white (that is, not colored), and the percentage of the spray coating amount and RGB color codes of each group are as shown in the table below. As shown in the table below, the colorant in the colorant tank 31 is A4 color forming ink, and thus as long as the percentage of the spray coating amount (volume) is controlled, different colors can be presented. For example, if the percentage of the spray coating amount of A4 color forming ink in coloring group G_{c1} is 100%, the spray coating amount of A2 color forming ink in coloring group G_{c4} is half (50%) of that of the spray coating amount of the coloring group G_{c1}. However, it is noted that the method of controlling the specific spray coating amount can be realized simply through the inkjet control method of the grayscale graphics. In this embodiment, RGB value control is adopted. That is, RGB values are used to present different grayscale levels.

| Coloring | Color | Percentage of spray | | | |
|---|---|---|---|---|---|
| group | code | coating amount | R | G | B |
| G_{c6} | White | 0% | 255 | 255 | 255 |
| G_{c5} | A1 | 38% | 158 | 158 | 158 |
| G_{c4} | A2 | 50% | 128 | 128 | 128 |
| G_{c3} | A3 | 56% | 112 | 112 | 112 |
| G_{c2} | A3.5 | 67% | 84 | 84 | 84 |
| G_{c1} | A4 | 100% | 0 | 0 | 0 |

The following describes the manufacturing process of this embodiment: Firstly, the main controller 5 controls the slurry layering module 2 to uniformly lay the slurry from the slurry tank 20 on the substrate 6 to form a slurry layer Lₛ. the slurry layer Lₛ is dried in such a manner that the substrate 6 absorb a portion of the moisture in the slurry layer Lₛ for a few seconds. Next, the main controller 5 controls the coloring module 3 to color the slurry layer Lₛ with a colorant according to the corresponding coloring parameter data 512 to form a colorant layer L_{c}. In this step, if the predetermined thickness t of the sliced layer is comparatively thick, a few seconds may be needed to allow the colorant to gradually precipitate into the slurry layer Lₛ, so that the color formation of the slurry layer Lₛ is uniform. On the contrary, if the predetermined thickness t of the sliced layer is comparatively thin, no waiting time is needed.

Furthermore, the main controller 5 controls the light curing module 4 to emit UV light on the slurry layer L_{c} according to a corresponding laminated graphic 511, so as to cure the portion to be formed. As such, it is only necessary to repeat the steps of laying the slurry layer Lₛ, coloring, and light curing until the crown ceramic green body is formed. Finally, after the uncured slurry is removed, the crown ceramic green body is sintered at a high temperature to form a dental ceramic crown. The sintering temperature for ceramics is in the range of 1100° C. to 1700° C. (in general, the sintering temperature is 1100° C. to 1300° C. for glass ceramics, 1300□-1600□ for zirconia, and 1300□-1700□ for alumina) to produce a colored dental ceramic crown having a smooth and flat surface.

Reference is made to FIG. 4, which is a view schematically showing the coloring image of the second embodiment of the present invention. The second embodiment is mainly different from the first embodiment in that the coloring parameter data 512 of the first embodiment are obtained based on a match in color with the patient's natural teeth or adjacent teeth. That is, the coloring parameter data 512 are edited according to the color of the natural teeth or adjacent tooth. However, in this embodiment, a coloring image is obtained by scanning or photographing a reference tooth or an original crown to be replaced, which is then sliced in a predetermined direction at a predetermined thickness to obtain a plurality of coloring parameter data 512.

Taking FIG. 4 as an example, if one wishes to prepare a coloring image of the crown C_{R1} to be formed, one may photograph or scan the incisor tooth C_{f1} (also known as the homonymous tooth) as the reference crown, since the shape, size, or color of them are usually close to each other. As such, it is appropriate to take it as a reference for molding or coloring. Alternatively, the coloring image of the crown C_{R1} also can be obtained by photographing or scanning the original crown to be replaced. Furthermore, if it is desired to prepare the coloring image of crown C_{R2} to be formed, one may photograph or scan the side tooth C_{f3} as the reference crown, or use the homonymous tooth C_{f2} at the corresponding side as the reference crown. In other words, this embodiment, in particular, photographs or scans the original crown to be replaced, side teeth, or homonymous teeth as the reference crowns, and shape, size, or color of the dental ceramic crown formed is natural. Besides, it is unnecessary to manually draft or edit the color image or data for the dental ceramic crowns, and the process is automated.

FIG. 5 is a cross-sectional view of the dental ceramic crown according to the third embodiment of the present invention. This third embodiment is different from the first and second embodiments in the coloring steps. In the first and second embodiments as described hereinbefore, the colorant is spray-coated on the overall slurry layer Lₛ, that is to say, the colorant layer L_{c}, completely overlaps the slurry layer Lₛ. However, in this third embodiment, only the outer surface of the dental ceramic crown which is the surface of the ceramic crown exposed from the oral cavity is colored.

In particular, as shown in FIG. 5, in this embodiment, the colorant layer L_{c}, is a region of a specific width w formed along about three-quarter of the outer circumference of the slurry layer Lₛ. This will not only save colorant used, but can also reduce the spray-coating and coloring time. In addition, it is noted that although the foregoing embodiments are described with reference to the dental ceramic crown that imitates natural teeth and present a color gradient, the present invention shall not be limited to this. Specific patterns may formed on the surface of the dental ceramic crown. For example, in FIG. 5, the colorant layer L_{c} comprises two color blocks, in which the first color block Z_{c1} is taken as the background color, and the second color block Z_{c2} is taken as the pattern color. After lamination, the second color zone Z_{c2} will present a fine pattern. Accordingly, the present invention may also form more diverse and finer patterns on the dental ceramic crown, and the pattern as formed is difficult to be damaged or destroyed, and may be kept on the dental ceramic crown for a long time.

The preferred embodiments of the present invention are illustrative only, and the claimed inventions are not limited to the details disclosed in the drawings and the specification. Accordingly, it is intended that it have the full scope permitted by the language of the following claims.

What is claimed is:

1. An apparatus for three-dimensional laminating and coloring a dental ceramic crown, comprising:
a slurry layering module having a slurry tank receiving a slurry therein;
a coloring module having at least one colorant tank storing a colorant therein:
a light curing module; and;
a main controller electrically connected to the slurry layering module, the coloring module and the light curing module; the main controller comprising a memory module storing a plurality of laminated graphics obtained by slicing a three-dimensional image (# model image) for the dental ceramic crown to be formed at a predetermined thickness in a predetermined direction, and a plurality of coloring parameter data corresponding to the plurality of laminated graphics; wherein the main controller is configured to control the slurry layering module to lay a slurry layer with the slurry in the slurry tank, to control the coloring module to color the slurry layer with the colorant in the at least one colorant tank to form a colorant layer according to a plurality of coloring parameter data, and to control the light curing module to cure the slurry layer according to the plurality of laminated graphics.

2. The apparatus of claim 1, wherein the main controller is configured to categorize the plurality of coloring parameter data into a plurality of coloring groups, and each of the plurality of coloring groups is configured to color the slurry layer in a specific spray-coating amount or color.

3. The apparatus of claim 2, wherein the main controller categorizes the plurality of coloring parameter data into the plurality of coloring groups based on RGB color codes.

4. The apparatus of claim 2, wherein the spray-coating amount of each coloring group to color the slurry layer gradually decrease from a cervical portion toward an incisal portion or an occlusal portion of the dental ceramic crown to be formed.

5. The apparatus of claim 1, wherein the colorant in the at least one colorant tank is a mixture of a solvent and at least one selected from a group consisting of ferric nitrate, ferric chloride, praseodymium nitrate, and praseodymium chloride, or a mixture of the solvent and at least one selected from a group consisting of erbium nitrate, erbium chloride, neodymium nitrate, neodymium chloride, cerium nitrate, and cerium chloride; and the solvent is at least one selected from a group consisting of water, methanol, ethanol, isopropanol, n-propyl alcohol, polar aprotic liquid and ethyl acetate.

6. A method for three-dimensional laminating and coloring a dental ceramic crown, comprising:
a step (Sa) of preparing a slurry, at least one colorant, a plurality of laminated graphics and a plurality of coloring parameter data corresponding to the plurality of laminated graphics, the laminated graphics being obtained by slicing a three-dimensional image of the dental ceramic crown to be formed at a predetermined thickness in a predetermined direction;
a step (Sb) of laying the slurry on a substrate to form a slurry layer;
a step (Sc) of coloring the slurry layer with the at least one colorant color by a coloring module according to one of the plurality of coloring parameter data to form a colorant layer;
a step (Sd) of curing the slurry layer by a light curing module according to one of the plurality of laminated graphics;
a step (Se) of repeating the steps (Sb) to (Sd) to form a ceramic crown green body; and
a step (Sg) of sintering the ceramic crown green body at a high-temperature to form the dental ceramic crown.

7. The method of claim 6, wherein the step (Sa) further comprises categorizing the plurality of coloring parameter data into a plurality of coloring groups by a main controller, and each of the plurality of coloring groups is configured to color the slurry layer in a specific spray-coating amount or color.

8. The method of claim 7, wherein the spray-coating amount of each of the plurality of coloring groups to color the slurry layer gradually decreases from a cervical portion toward an incisal portion or an occlusal portion of the dental ceramic crown to be formed.

9. The method of claim 6, wherein the step (Sc) further comprises coloring at least a portion of a circumference of the slurry layer with the at least one colorant by the coloring module according to one of the plurality of coloring parameter data to form the colorant layer.

10. The method of claim 6, further comprising a step (S0) of providing a coloring image before the step (Sa), wherein the coloring image is obtained by scanning or photographing a reference crown or an original crown to be replaced, and the plurality of coloring parameter data are obtained by slicing the coloring image in the predetermined direction at the predetermined thickness.
